(19) United States
(12) Patent Application Publication
(10) Pub. No.: US 2022/0057013 A1
(43) Pub. Date: Feb. 24, 2022

(54) SHUT-OFF VALVE

(71) Applicant: Andre Joachim Henry DU RAND, Western Cape (ZA)

(72) Inventor: Andre Joachim Henry DU RAND, Western Cape (ZA)

(21) Appl. No.: 17/413,208

(22) PCT Filed: Dec. 11, 2019
(86) PCT No.: PCT/ZA2019/050074

§ 371 Date: Jun. 11, 2021

(30) Foreign Application Priority Data
Dec. 11, 2018 (ZA) 2018/08338

(51) Int. Cl. F16K 31/22; F16K 31/28; F23K 5/14

(52) U.S. Cl. CPC F16K 31/22; F02D 33/003; F23K 5/147; F16K 31/28

(57) ABSTRACT

The invention provides a shut-off valve (10) for a hydrocarbon liquid or fuel intake. The valve includes a first float body (14) configured to float at the surface of hydrocarbon fuel (15), a fuel intake (16) located on the first float (14) and positioned such that the intake (16) is below the surface of the fuel (15), in use, and a second float body (18) configured to float on water (20) and sink in hydrocarbon fuel (15) such that the body (18) floats at an interface of hydrocarbon fuel (15) and water (20) phases, in use. A closing means (24) is located on the second float (18) for closing or restricting the fuel intake (16) when the first float (14) and second float (18) are in contact or in close proximity and further includes a guide arrangement (26) for guiding the first and second float (14, 18) towards each other as the surface of the hydrocarbon fuel (15) approaches the fuel water interface.

### TECHNICAL FIELD OF THE INVENTION

This invention relates to a valve located at a hydrocarbon fuel intake which prevents the intake of water.

### BACKGROUND TO THE INVENTION

Hydrocarbon fuels such as diesel are stored in tanks. Often water gets into the tanks and settles at the bottom of the tank. When the diesel is removed from the tank to be used in an engine or when it is transferred to another storage or transport facility the water is removed or transferred with the diesel. Normally the intake is located at the bottom of the tank and the water is the first to be removed from the tank. The presence of water in diesel is undesirable and it causes a number of problems. In particular it is a problem when starting diesel engines. The water which precedes the diesel prevents the starting of diesel engines leading to failure of the battery and/or electric starter motor. In addition, water can cause failure of the diesel pump, injectors and other parts of a diesel engine. When the tanks or diesel in the tanks needs to be cleaned it is preferable to remove the diesel in the tank separately from the water layer at the bottom of the tank.

It is an object of the invention to provide a valve for a hydrocarbon fuel intake, which shuts off or causes an engine to shut off before water enters the intake.

### GENERAL DESCRIPTION OF THE INVENTION

According to the invention there is provided a shut-off valve for a hydrocarbon liquid or fuel intake, which valve includes:

a first float body configured to float at the surface of hydrocarbon fuel;

a fuel intake located on the first float and positioned such that the intake is below the surface of the fuel, in use,

a second float body configured to float on water and sink in hydrocarbon fuel such that the body floats at an interface of hydrocarbon fuel and water phases, in use;

a closing means located on the second float for closing or restricting the fuel intake when the first float and second float is in contact or in close proximity; and

a guide arrangement for guiding the first and second float towards each other as the surface of the hydrocarbon fuel approaches the fuel water interface, in use.

The closing means may be configured to prevent further liquid uptake or in other embodiments it may restrict fuel intake which will cause an engine to starve and shut down thereby preventing further fuel or water uptake.

The shut-off valve may include an intake pipe. The pipe may be configured to follow the first float as the level of the hydrocarbon fuel drops, in use. The pipe me be resiliently retractable or coiled such that the pipe is in a compact state when the hydrocarbon fuel level is high and elongated state when the hydrocarbon fuel level is low. The pipe may be a flexible poly urethane hose.

The guide arrangements may be in the form of two or more guide rods. The first and/or second float may be generally circular and may be provided with corresponding vertical holes near its outer edge for respectably slidably receiving the guide rods there through. The retractable pipe or coiled pipe may preferably fit between the guide rods. Three or more guide rods are preferable to capture or contain the intake pipe within the circularly arranged rods.

Alternatively, the guide arrangement may be a perforated hollow cylinder within which the floats can move freely and within which the retractable pipe or coiled pipe may fit.

The fuel intake opening is located at the bottom of the first float. The opening may be conically or frusto-conically shaped with a matching male formation located on the top of the second float such that the opening is closed when the floats meet. The cone shape assists to guide the closure formation into the opening and to form a seal.

In another embodiment, the guide arrangement may be a perforated hollow cylinder, preferably of stainless steel. The first float may be provided with a hole which fits over the cylinder and which float can move freely over and along the cylinder and the second float may fit inside and may move freely inside the hollow cylinder. The hollow cylinder is closed off at its operatively lower end. It is to be appreciated that the fuel uptake takes up fuel through the perforations of the hollow cylinder above the level of the second float and when the two floats reaches a corresponding level, fuel intake is prevented or restricted. To allow sufficient fuel flow, the first float may be cylindrical and provided with intake passages from its upper surface to the outside of its sides.

In the case of causing restricted fuel flow to starve a diesel engine to shut-off it is an advantage that the diesel piping and injectors do not run dry and a complicated restart of the engine is prevented. One way valves may be installed in the piping to prevent back flow of the diesel in case of shut-off.

In a further embodiment the guide arrangement may be a rod, preferably of stainless steel. The first and second floats may each be provided with a hole which fits over the rod and which floats can move freely over and along the rod. The first float may be cylindrical and is provided with intake passages extending from its operatively lower end to its upper end into the retractable pipe. The second float will close these intake passages when the two floats are in contact.

The shut-off valve may include an attachment means for attaching to an opening at the top of the tank. The attachment means may resemble the cap of the tank so that it attaches with a similar mechanism as the cap when the tank is closed.

The floats may be manufactured from High Density Polyethylene (HDPE) or other suitable material. The float may be provided with gas filled cavities or weighted, if adjustment is needed to ensure the first float floats on the surface of the diesel with the retractable pipe connected to it and that the second float floats on water but sinks in hydrocarbon fuel.

It is to be appreciated that the invention can be applied in any chemical, food production or mining application where separated liquid layers occur to remove to upper liquid layer separately from the lower layer of liquid.

### DETAILED DESCRIPTION OF THE INVENTION

The invention is now described by way of example with reference to the accompanying drawings.

In the drawings:

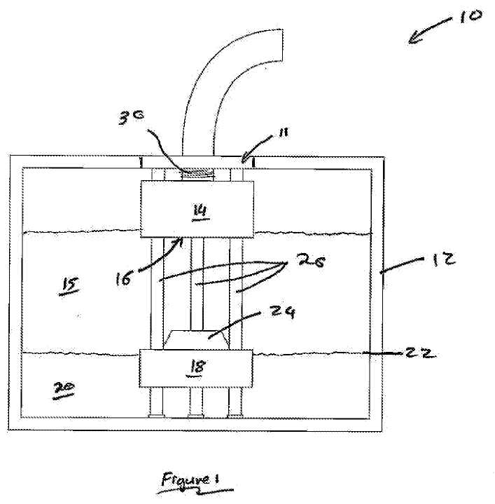

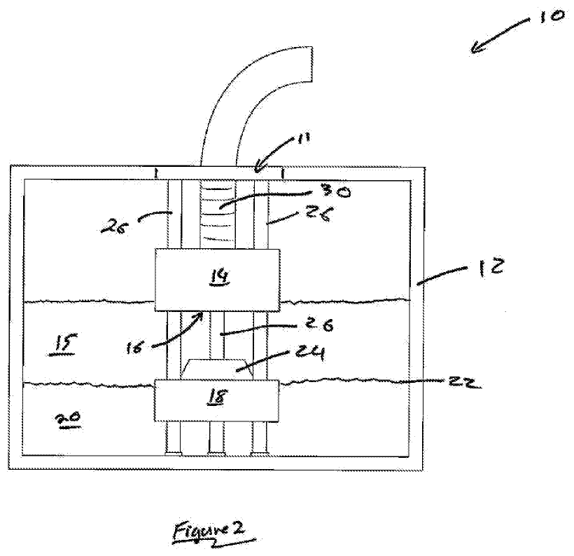

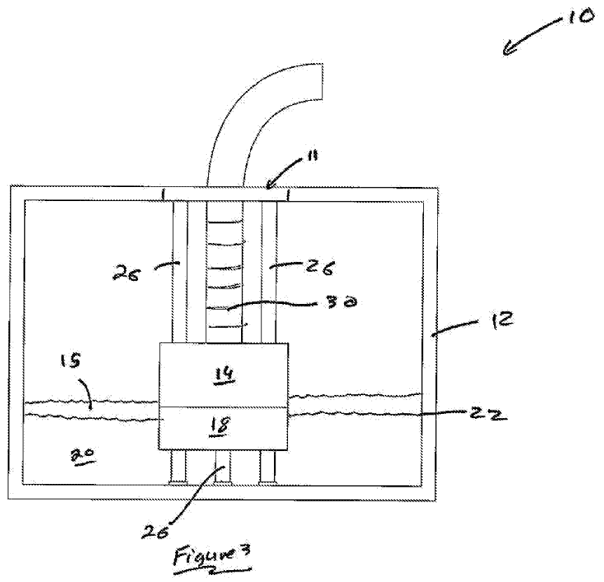

FIGS. 1 to 3 shows schematically a side view of the working of a shut-off valve for a hydrocarbon fuel intake, in accordance with the invention;

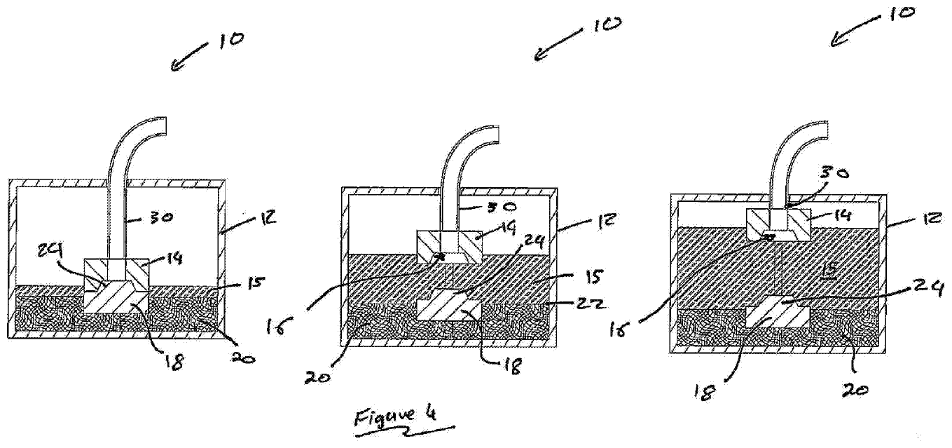

FIG. 4 shows a cross sectional side view of the working of a shut-off valve for a hydrocarbon fuel intake;

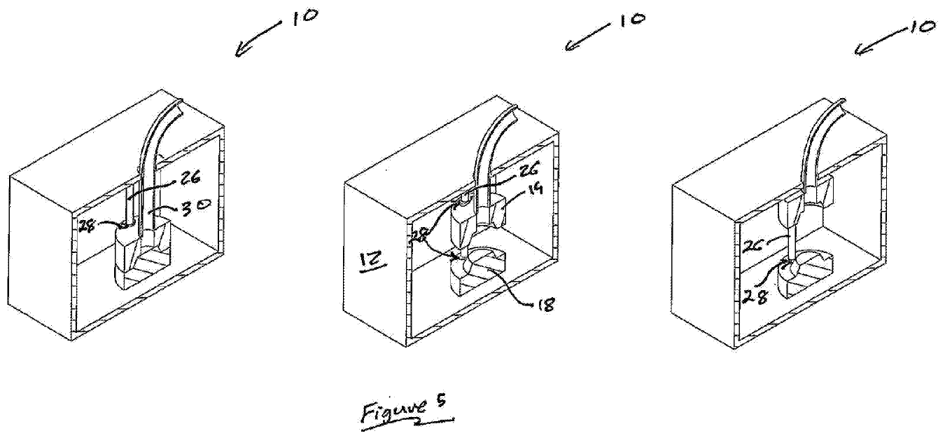

FIG. 5 shows a perspective view of the working of a shut-off valve for a hydrocarbon fuel intake; and

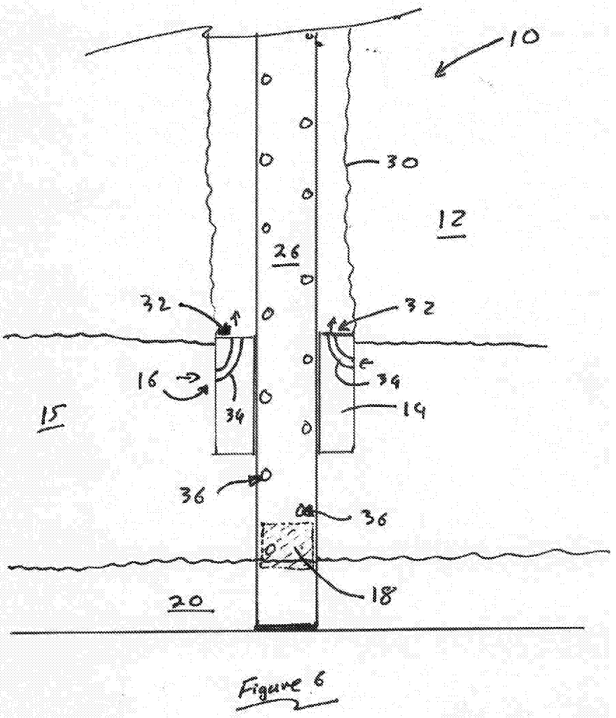

FIG. 6 shows schematically a side view of a further embodiment of a shut-off valve.

Referring now to the drawings 1 to 5, one embodiment of the shut-off valve. The shut-off valve for a hydrocarbon fuel intake, in accordance with the invention, is generally indicated by reference numeral 10.

The shut-off valve 10 is installed in an upper opening 11 of a diesel tank 12. The Shut-off valve 10 includes a first float 14 body of HDPE configured to float at the surface of the diesel 15 with a fuel intake located on the first float and positioned such that the intake opening 16 is below the surface of the diesel, in use. The diesel intake opening 16 is located at the bottom of the first float 14 and the opening is frusto-conically shaped.

The valve 10 further includes a second float body 18 of HDPE configured to float on water 20 and sink in diesel such that the body floats at an interface 22 of diesel and water phases, in use. A closing means 24 in the form of a male formation which matches the shape of the diesel intake opening 16 is located on the second float 18 for closing the fuel intake when the first float 14 and second float 18 is in contact.

The valve 10 further includes a guide arrangement in the form of guide rods 26 for guiding the first 14 and second 18 float towards each other as the surface of the diesel 15 approaches the diesel water interface 22, in use. The first 14 and second 18 float is circular in plan view and is provided with corresponding vertical holes 28 near its outer edge for respectably slidably receiving the guide rods 26 there through. It is to be appreciated that the diesel will provide lubrication for the guide arrangement.

The shut-off valve 10 includes an intake pipe 30. The pipe 30 is configured to follow the first float 14 as the level of the diesel drops, in use. The pipe 30 is resiliently retractable and in a compact state when the diesel 15 level is high and elongated state when the diesel level is low.

The shut-off valve includes an attachment means (not shown) for attaching to an opening at the top of the tank 12. The attachment means resembles the usual closure cap of the tank 12 so that it attaches with a similar mechanism as the cap when the tank is closed and the valve 10 removed.

Use of the invention in a diesel generator fuel tank, which tank contains a layer of water will allow the generator to start and use diesel from the top down and the valve will shut off the fuel flow automatically before water can enter the intake opening. The retractable hose allows the valve to be installed vertically in any shape tank through a small opening at the top of the tank.

With reference to FIG. 6, according to another embodiment of the invention there is provided a shut-off valve 10 for a hydrocarbon liquid or fuel intake.

The shut-off valve 10 is installed in an upper opening of a diesel tank 12. The Shut-off valve 10 includes a first float 14 body of HDPE configured to float at the surface of the diesel 15 with a first fuel intake 32 located on the first float and positioned such that the intake opening 16 is below the surface of the diesel, in use. The first float 14 is cylindrical and provided with intake passages 34 from its upper surface inside the flexible hose 30 to the outside of its sides.

A guide arrangement 26 is in the form of a perforated hollow cylinder, preferably of stainless steel. The first float 14 is cylindrical and provided with a hole which fits over the cylinder 26 and which float can move freely along the cylinder. The second float 18, which floats on water 20 but not on hydrocarbon fuel fits inside and may move freely inside the hollow cylinder 26. The hollow cylinder 26 is closed off at its operatively lower end. It is to be appreciated that the fuel uptake takes up fuel through the perforations 36 of the hollow cylinder 26 above the level of the second float and when the two floats reaches a corresponding level, fuel intake is restricted to the first fuel intake 32. The first fuel intake 32 is configured to provide insufficient fuel to an engine, the engine is starved and shuts off, preventing uptake of further fuel and/or water.

The shut-off valve may be provided with a pivot joint to keep the shut=off valve from extending vertically into the fuel tank.

It shall be understood that the examples are provided for illustrating the invention further and to assist a person skilled in the art with understanding the invention and are not meant to be construed as unduly limiting the reasonable scope of the invention.

1. A shut-off valve for a hydrocarbon liquid or fuel intake, which valve includes:
a first float body configured to float at the surface of hydrocarbon fuel;
a fuel intake located on the first float and positioned such that the intake is below the surface of the fuel, in use,
a second float body configured to float on water and sink in hydrocarbon fuel such that the body floats at an interface of hydrocarbon fuel and water phases, in use;
a closing means located on the second float for closing or restricting the fuel intake when the first float and second float is in contact or in close proximity; and
a guide arrangement in the form of a perforated hollow cylinder for guiding the first and second float towards each other as the surface of the hydrocarbon fuel approaches the fuel water interface, in use.

2. A shut-off valve as claimed in claim 1, which includes an intake pipe, which pipe is configured to follow the first float as the level of the hydrocarbon fuel drops, in use.

3. A shut-off valve as claimed in claim 2, wherein the pipe is resiliently retractable or coiled such that the pipe is in a compact state when the hydrocarbon fuel level is high and elongated state when the hydrocarbon fuel level is low.

4-5. (canceled)

6. A shut-off valve as claimed in claim 1, wherein the fuel intake opening is located at the bottom of the first float, which opening is closed when the floats meet.

7. (canceled)

8. A shut-off valve as claimed in claim 1, wherein the first float is provided with a hole which fits over the cylinder and which float can move freely along the cylinder and the second float which fits inside the cylinder and moves freely inside the hollow cylinder and which hollow cylinder is closed off at its operatively lower end.

9. A shut-off valve as claimed in claim 5, wherein the first float is cylindrical and provided with intake passages from its upper surface to the outside of its sides.

10. A shut-off valve as claimed in claim 1, which includes an attachment means for attaching to an opening at the top of the tank.

11. A shut-off valve as claimed in claim 1, wherein the floats are manufactured from High Density Polyethylene (HDPE) and provided with gas filled cavities or weights, as required.

12. (canceled)
